(19) United States
(12) Patent Application Publication
(10) Pub. No.: US 2005/0086380 A1
(43) Pub. Date: Apr. 21, 2005

(54) Arrangement relating to one or more control systems

(76) Inventors: Lars-Berno Fredriksson, Molndal (SE); Daniel Berglund, Partille (SE)

Correspondence Address: CONNOLLY BOVE LODGE & HUTZ LLP, SUITE 800, 1990 M STREET NW, WASHINGTON, DC, 20036-3425, US

(21) Appl. No.: 10/497,031

(22) PCT Filed: Nov. 25, 2002
(86) PCT No.: PCT/SE02/02161

(30) Foreign Application Priority Data
Nov. 30, 2001 (SE) 0104015-3

(51) Int. Cl. G06F 15/16; G06F 17/30; G06F 7/00

(52) U.S. Cl. 709/246; 707/4; 709/201

(57) ABSTRACT

An arrangement is connected to a distributed control system with modules connected as nodes to one or more connections in a communication system that operates with communication protocol. The arrangement comprises two or more interacting computer programs or tools for development, maintenance, etc, of the control system. A first computer program generates data relating to additional information or identification information. A second computer program is arranged to determine, using the identification information, whether the generated data can be processed in the second computer program. A data repository is arranged to store without sorting various data with the identification information, which stored data is arranged in a first data format. The respective computer program can retrieve data from or input data to the data repository. The respective computer program works with a database, and is arranged to change the format from the first data format to the second data format. By means of the invention, more rapid production of tools is made possible, with fewer sources of error.

The present invention relates to an arrangement relating to one or more distributed control systems (Distributed Embedded Control Systems) that comprise interacting modules connected as nodes to one or more connections, preferably few-wire and/or wireless connections, in a communication system that operates with communication protocol, for example CAN, Ethernet, UDP/IP, Bluetooth, IEEE 802.11, etc. The arrangement utilizes for this purpose two or more interacting computer programs or tools for development and/or maintenance of the control system.

In connection with system production, the division of the different system constructions and system functions into different levels and areas that are allocated to various experts who are expected to be able to work towards an overall system construction and system function is already known. In large system types, a plurality of experts is often employed in order to be able to produce the tool and/or the system in question within a reasonable time. The division of the work can thereby be carried out in system construction, module construction, specifying, verifying, validating, analysis, etc.

In particular for large and more complicated systems and tools, for production and/or maintenance of control systems, there is a need to be able to obtain a better overview of production and maintenance methods and to be able to obtain better systems with fewer sources of error. Thus, for example, it is important to be able to obtain a better implementation throughout the whole system for changes that arise during the course of the work. Thus, for example, a change at module level that affects previous assumptions for the system construction must be able to be carried through so that ambiguities and errors do not arise. In general, there is also a need to be able to separate efficiently the system levels and module levels from an operational point of view and to obtain a better integration between the different parts of the system during the system production. Different tools for solving different system construction parts and system functions must be able to be coordinated better. In addition, the partial and whole solutions that are produced must be easy to check. An object of the present invention is, among other things, to solve this problem.

There is thus a need to be able to obtain better system solutions in general. The system specification must be able to be implemented in the system so that “side information” on paper or other media can be avoided. There is also a need to be able to simplify the comparison procedures between the different system parts and it must be possible to use interactive methods. Among other things, it is essential to be able to verify, for example at system level, that all modules have components that are correct and are the right price, for example connectors, the availability of which can vary during the production of computer programs, tools, systems, that can take, for example, two years. During this period of time, the components available can, for example, become cheaper, and for reasons relating to price it can become desirable to use different components to those that were proposed initially, etc. The principle of one type of problem at a time must also be applicable. The invention also intends to solve this problem. By means of the invention, it is thus possible to compensate for changes in the specification that can arise during the course of the work. In addition, linking functionality can be used in the repository, which provides an elegant solution for unambiguous retrieval of information.

Modern system development comprises a partial method in which there is initially a rough system specification for the implementation of the module design. The system and module specifications are refined interactively and are updated at regular intervals. This makes great demands for updates to be able to be carried out simultaneously at system and module level.

It is important that well-tested techniques, methods and arrangements can be utilized in connection with the production of tools, computer programs and systems. The invention also solves this problem.

The principal characteristic of an arrangement according to the invention is, among other things, that a first computer program of the said computer programs is arranged to generate data relating to additional information, here designated identification information, and a second computer program of the said computer programs is arranged to determine, using the identification information, whether the data generated by the first program can be processed in or by the second program. Additional characteristics are that one or more data repositories are arranged to store without sorting various data with associated identification information, which data is arranged in one or more first data formats. The respective computer program is further arranged to input to and/or retrieve from the respective data repository data (information) relevant for the computer program, and the respective computer program is further arranged to work with a database, preferably a local database, with data arranged in a second data format. Finally, the invention is characterized in that the respective computer program is arranged to change the format from the first data format to the second data format when retrieving data from the repository concerned.

Further developments of the concept of the invention are apparent from the subsequent subsidiary claims.

By means of what is proposed in the above, complicated and more comprehensive systems can also be developed and maintained without the danger arising of sources of errors of various kinds. Tools for this purpose can be designed unambiguously and with relatively few sources of error. The production of tools, etc, can be carried out more rapidly and the production times can be reduced by up to approximately 50% for corresponding systems. The separation and reconnection functions can be improved considerably and the whole operation from concept to product can be simplified and implemented in a better way. In addition, maintenance and fault-finding are improved. The system and tool production can be modularised in an outstanding way and the concept can be extended gradually. Duplication of work with entry of data in different partial steps can be avoided by the utilization of the said repositories.

A currently proposed embodiment of an arrangement that has the significant characteristics of the invention will be described below with reference to the attached drawings in which

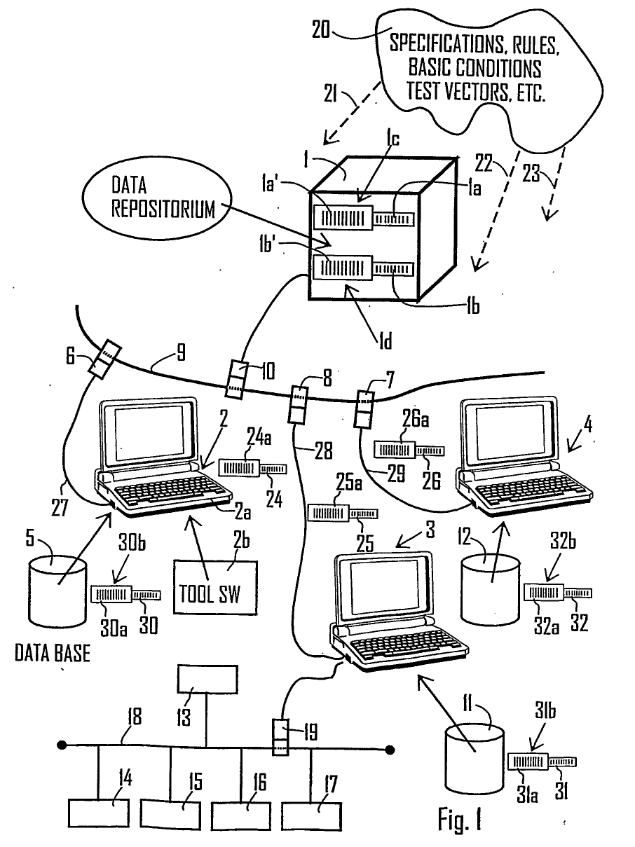

FIG. 1 shows in block diagram form and in outline a number of tools (computer programs+computers) that can interact with each other and a repository via a connection, which tools are provided with or can interact with databases, for example local databases,

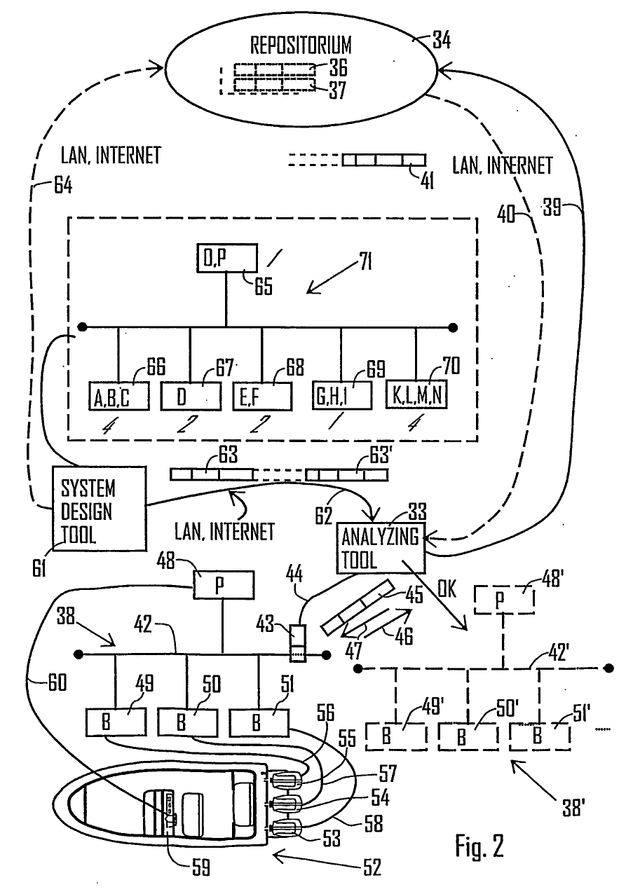

FIG. 2 shows in block diagram form and in outline tools (computer programs+computers) in the form of design or development tools and analysis tools,

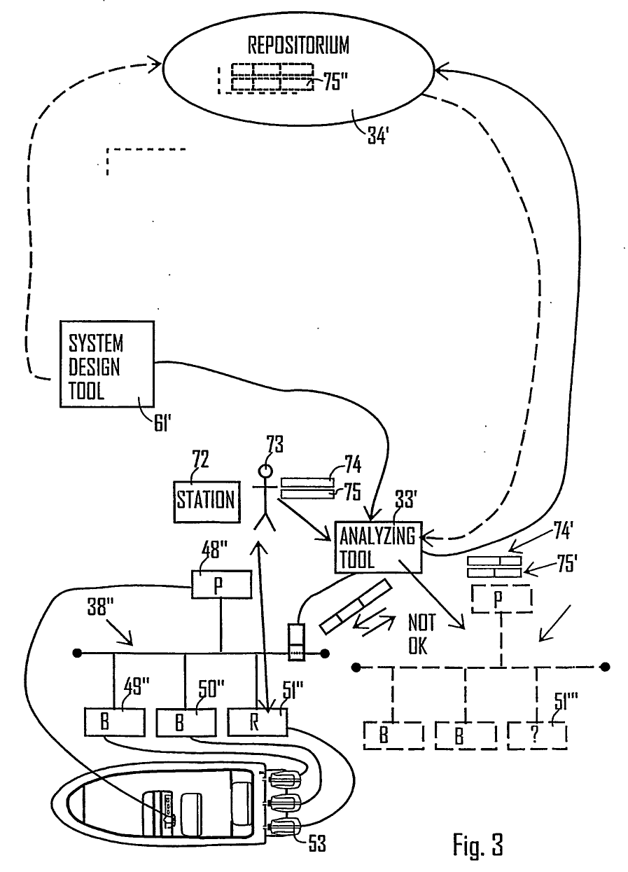

FIG. 3 shows in block diagram form and in outline an embodiment that is different from the embodiment according to FIG. 2 in connection with analysis tools,

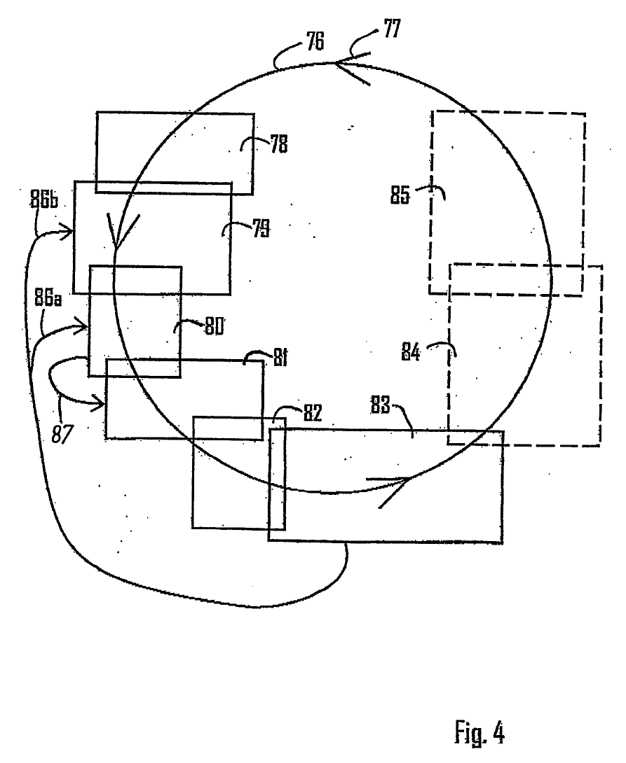

FIG. 4 shows in block diagram form and in outline a production cycle for a control system implemented by a number of tools/programs that can interact, which tools/programs are utilized in different steps,

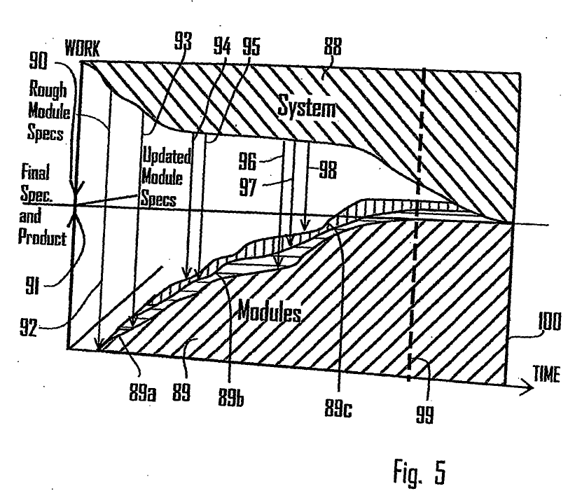

FIG. 5 shows in diagram form parallel development functions for a CAN KINGDOM SYSTEM, and

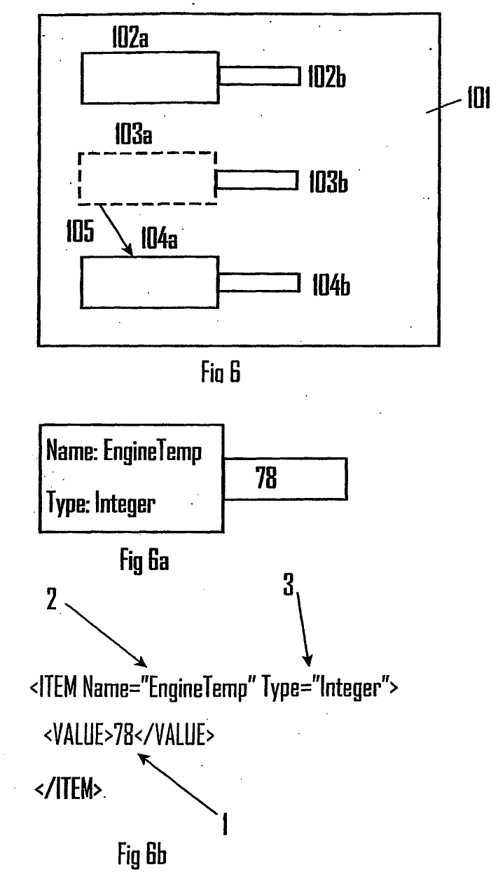

FIGS. 6, 6a and 6b show in diagram form data (information) held in the repository with the use of linking and the data is tagged or provided with additional information or identification information.

In FIG. 1 a data repository is indicated by 1. A number of tools are shown by 2, 3, 4. The respective tools comprise or consist of a computer 2a and one or more computer programs 2b that can be utilized in this. The tool 2 utilizes and is connected to a database 5 allocated to it, which database can consist of a local database. The tools are provided with connectors 6, 7, 8, via which the tools are connected to a connection 9 that can be incorporated in a telecommunication and/or data communication network, for example LAN (Local Area Network), Internet, etc. The repository is also provided with a connector 10. The tools 2, 3 and 4 can be constructed in a corresponding way to that shown for the tool 2. In the case of tools 3 and 4 only the respective associated databases, for example local databases, are indicated by 11, 12. The different tools can be allocated different steps or functions in the development of a distributed control system which can consist of, for example, CAN (Control Area Network) or other similar system in accordance with the above. The tool 3 can consist of an analysis tool and the tool 4 can represent tools for specifying, verifying, validating, and/or analysis, etc. In FIG. 1, a typical control system has also been shown. The control system can comprise a master unit 13 and modules 14, 15, 16, and 17 acting as nodes. The master unit and the modules are connected to a connection 18 incorporated in the system which connection can consist of a few-wire connection 18, a coaxial cable connection, a wireless connection (optical or radio connection), etc. The analysis tool 3 is connected to the connection via a connector 19. In the system or arrangement shown in FIG. 1, there is a high-level rule system, specification, etc, which is symbolized by 20 and arrows 21, 22 and 23 that show symbolically the implementation of the rules, specification, etc, in the system or the arrangement.

The respective tools or computer programs can be arranged to generate data 24, 25 and 26 respectively related to or provided with additional information 24a, 25a and 26a respectively, which additional information consists of identification information containing information about the data format utilized, data type, unit, origin, relationship to other information, etc. Using the identification information, each tool or computer program can determine whether data generated by a second computer program can be processed in the first computer program. The data repository 1 is arranged to store without sorting different data 1a, 1b, etc, with associated identification information 1a′ and 1b′ respectively. The repository's stored data is in a first data format which is symbolized in FIG. 1 by 1c and 1d respectively. The respective tools or computer programs 2, 2b, 3 and 4 respectively are arranged to export or input to and/or import or retrieve data or information from the repository via their connections 27, 28 and 29 and connectors 6, 7, 8, which data or information is relevant for the tool or computer program. The respective databases work with data 30, 31 and 32 respectively, the identification information for which is indicated by 30a, 31a and 32a and second data format is symbolized by 30b, 31b and 32b respectively. The respective computer programs 2b in the tools 2, 3, 4 are arranged when retrieving data 1a, 1b in the repository to change the format from the first data format 1c, 1d to the respective second data format 30b, 31b and 32b respectively, during which process superfluous information is removed and internally generated information is added and the information thus created for local use is sorted in the local database in a suitable way for this. If some information that is required is missing from the repository, the operator can be informed of this and can enter the information in question manually. The components, tool, repository, etc, shown in FIG. 1 can consist of known types and will therefore not be described here in greater detail, instead reference being made to generally known technology.

In FIG. 2, an analysis tool is indicated by 33. In a first step, the analysis tool can be arranged to retrieve from the data repository 34 data or information 36, 37 that is relevant for the system analyzed by the analysis tool 33 for the creation of the computer module 38′ by the system 38. The data in question 36, 37 can consist, for example, of protocol information that can consist of J 1939, DeviceNet, etc, information about which ECUs are relevant to the system, etc. The retrieval of data from the repository can be carried out via connections 39, 40 in the relevant telecommunication and/or data communication network LAN, Internet, etc. The transmission on the connection or connections in question is carried out by means of digital signals or messages, packets, etc, and has been symbolized by 41. The analysis tool is connected to the analyzed control system 38, 38′ via a connection 42, 42′ according to the above. The connector has been symbolized or indicated by 43 and the analysis can be carried out via a connection in the said telecommunication and/or data communication network which is symbolized by 44. The analysis is carried out using signal transmissions on the connection 44 and the information or messages have been indicated by 45. The connection is bi-directional, which has been indicated by the arrows 46, 47. In addition, the analyzed system has been represented by a high-level unit 48, 48′ and modules or nodes 49, 49′; 50, 50′; and 51, 51′. The analyzed object or the analyzed equipment consists in this case of a vessel/boat 52 that utilizes the control system 38 in question. The nodes are arranged in engines 53, 54 and 55 and connections to these engines are indicated by 56, 57 and 58 respectively. A control desk function is indicated by 59. The control desk function comprises or is connected to the high-level unit 48 via a connection 60. The analysis tool can also retrieve information or data from a design tool 61 and the retrieval can be carried out via a telecommunication and/or data communication network LAN, Internet, etc, and the retrieved information or the retrieved data is symbolized by means of the message 63, 63′. The design tool 61 can also be connected to the repository for export and/or import of data which is relevant for the design tool. The connection is indicated by 64 and can be included in the said telecommunication and/or data communication network LAN, Internet, etc. In a second step, the analysis tool is arranged to monitor the system 38 and the data communication established in this. The monitoring can form the basis for analysis when it is a question of defining the characteristics of the system 38, for example type of protocol, ECUs, message frequencies, or other functions. In a third step, the analysis tool can actively participate in the system and effect interrogation of ECUs, transmission of control data, etc. In a fourth step, the analysis tool can generate a report about the current system characteristics in the said first format sent to the data repository via, for example, the connection 39. The analysis tool can thus ratify the system 38 and construct an analysis picture 38′ of the system. If the actual system in the object 52 is fault-free or ratified, a corresponding fault-free analysis function 38′ is obtained which can be reported to the relevant authority within the system and/or to the repository. The retrieval of the information from the system tool can give instructions concerning how the system 38 can appear and how it is categorized. The basic function of the designed system comprises in the present case (in accordance with the analyzed system 38) a high-level unit 65 and modules 66, 67, 68, 69 and 70. In accordance with the design, there is to be one high-level unit. The module 66 is to be found in three variants A, B, C of at most four in number. The module 67 is to have a variant D and the highest number consists of two units, etc. The basic design shown in FIG. 2 is indicated by 71 and the analyzed system must thus have a corresponding basic design in order to be able to be approved by the analysis. In the present case, there is one high-level unit 48 and three identical modules 49, 50, 51 which thus means that the basic design for 38 conforms to the basic design 71, which results in approval or ratification of the system 38 according to the above.

FIG. 3 is intended to show the case where the analysis tool 33′ analyzes a not-approved system 38″. The units or modules 48″, 49′ and 50″ correspond to the approved design construction, while the module 51″, refers to a deviant function, for example due to the fact that the owner has replaced an engine 53 with an engine of a different type, size, etc. The analysis tool 33′ notes this difference and puts a question mark beside it in the module unit 51″, in the created simulation. This can be reported to the relevant authority within the system, for example a unit or station 72, a user 73, etc. The discrepancy can also be transmitted to the repository in accordance with the above.

A user 73 can add additional information into the system. In FIG. 3, this additional information is represented by 74, 75. The analysis tool can separate the information in question 74, 75 into information that is suitable for further processing and information that is not suitable for further processing, 74′ and 75′ respectively. The analysis tool can further be arranged so that it forwards information that is not suitable for further processing to the repository, in which the information that is not suitable for further processing is indicated by 75″. A second tool, for example the tool 2 or 4 in FIG. 2, can retrieve the data or information in question 75″ from the repository and, using for example additional information and processing, the second tool can generate information which the analysis tool or the system tool can then import from, for example, the repository and utilize. The processing and generation can be carried out in a known way.

A tool, for example the tool 2 or 4 or 61, can be used for the design of modules. The tool in question can generate models of modules and export these to the repository. A second tool for system design can be arranged to import models and modules and add information into the respective model to correspond to the designed system and give information at system level concerning how the modules are to interact, that is in summary to make a model of the system and export this information to the repository. An additional tool can be arranged to import the system model and simulate the system's function by adding parameters and variable information as a function of the time. In association with the design using a design tool, this can comprise an output that can be connected to the data connection of an actual system and that can generate data on this from simulated models. One or more simulated modules can thereby be replaced by actual modules and the tool can detect deviations between the behaviour of the actual modules and corresponding simulated modules and export the result of the detection to the repository. An additional design tool can thereafter be used to achieve an improved model of the system and its components using the generated data or the generated information. A design tool or analysis tool that is connected to a system in question while at the same time having access to the repository can, with the transmission of monitored data traffic and information from the repository, reconstruct a probable picture of the construction of the system, its components and its behaviour. An additional design tool can be arranged to import a model of a given system from the repository. The tool can be connected to the actual system and by monitoring and transmission of data traffic can verify that the actual system conforms to the model and, if this is not the case, can report deviations and export this information to the repository. The design tool can thereby be arranged to import from the repository such data that was generated by other design tools in order to generate models that conform better to reality or to give the respective user or designer information about deviations and specify remedies.

In FIG. 4, such a development cycle is shown by a circle or path 76 with directional arrows 77. The development cycle can symbolize different steps such as system development, module development, specifying, verifying, validating, analysis, etc. The circle can also represent a number of tools or development steps that are represented by 78, 79, 80, 81, 82, 83, 84 and 85. The development of a step, for example the step or tool 83, can mean that changes must be made in previous steps, for example in steps 79, 80, which is illustrated by the return arrows 86, 86a, 86b. The different development steps also mean that a current development step, for example the development step 80, results in preconditions for succeeding development steps, for example 81, which is indicated by 87, etc.

FIG. 5 is a work and time diagram in which the vertical axis indicates the amount of work and horizontal axis indicates the time. In FIG. 5, parallel production principles are shown for the system and modules, where 88 indicates the system work and 89 indicates the work with modules that can be carried out individually and in parallel for the different modules, marked 89a, 89b and 89c (representing three modules), 90 and 91 represent the directions for the system and module work. At the time 92 there is an overview or rough module specification and updated module specifications are shown at the times 93, 94, 95, 96, 97 and 98. At the time 99 the work is practically completed and at the end time 100 the specification and the system are completed simultaneously.

FIG. 6 shows how tagged data 102a, 103a, 104a in a file 101 with tags 102b, 103b, 104b in the file 101 use linking in order to avoid duplicated information. The tag 103b identifies unambiguously data 103a, which is identified with data 104a via the link 105. In an embodiment of linking, it is assumed that information is stored in the repository concerning a number of modules that communicate via a CAN bus. In addition, it is assumed that information is stored in the same repository concerning the structure of one or more systems that use these modules, which systems are incorporated in a particular model of car.

Important information for the system construction with the modules that are in the repository is the structure of the CAN messages that the respective modules can produce or consume. Such structure information can, for example, be that messages with identifiers contain engine temperature represented as an integer in the first octet in the message. With an XML fragment, this information can be represented, for example, as

<ITEM Name=“EngineTemp”> <TYPE>Integer</TYPE>

<SIZE>8</SIZE>
<START>0</START> </ITEM>

This information naturally belongs to the definition of the engine in question. For a particular system, in the example given a particular model of car, a table will often be compiled of all the CAN messages that can occur in the system and this will be stored in the repository. Such a table can be drawn up by copying the abovementioned structure information from the modules that are included in the system, but the information must then be maintained in two locations and there is no guarantee that the copies are consistent. In order to avoid this disadvantage, the invention proposes a procedure that creates links to the respective module's description of the message structure. Such a link can be represented by, for example, the following XML fragment:

<ITEM Name=“EngineTemp”> <LINK>reference
information</LINK>
</ITEM>

where “reference information” is data that refers to another location in the repository. The precise appearance of this reference information is dependent upon how the repository is organised. A method that can be used for the XML-based repository is to give each element in the XML file a unique identifier, for example an integer or a UUID, and then let the reference information in the link be this identifier.

FIG. 6a shows an example of how additional or identification information has been added to data. A temperature, “78” in the figure, has been given a name “EngineTemp” and a data type “Integer”. A tool that can interpret this additional information can use it to locate the temperature value in question in a repository that contains many temperatures.

FIG. 6b shows an example of how additional information can be represented using XML (extensible Markup Language). In this example, the value of a temperature (1) has been given additional information about name (2) and data type (3), so that a tool or the like that can interpret the additional information can search in a large quantity of information for the relevant temperature.

The invention is not limited to the embodiment described above, but can be modified within the framework of the following patent claims and invention concept.

1. Arrangement relating to one or more distributed control systems that comprise interacting modules connected as nodes to one or more connections, preferably few-wire and/or wireless connections, in a communication system that operates with communication protocol, for example CAN, Ethernet, UDP/IP, Bluetooth, IEEE 802.11, etc, and utilizing two or more interacting computer programs (tools) for development and/or maintenance of the control system, characterized in that a first computer program of the said computer programs is arranged to generate adapt relating to additional information, here designated identification information, in that a second computer program of the said computer programs is arranged to determine, using the identification information, whether the data generated by the first computer program can be processed in the second computer program, in that one or more data repositories are arranged to store without sorting various data with associated identification information, which data is arranged in one or more first data formats, in that the respective computer program is arranged to input to and/or retrieve from the respective repository data (information) that is relevant for the computer program, in that the respective computer program is arranged to work with a database, preferably a local database, with data arranged in a second data format, and in that the respective computer program is arranged to change the format from the first data format to the second data format when retrieving data from the repository concerned.

2. Arrangement according to claim 1, characterized in that the respective computer program (computer tool) is arranged to participate in one or more of the control system's production or life-cycle steps, for example system development, module development, specifying, verifying, validating, analysis, etc.

3. Arrangement according to claim 1 characterized in that one of the computer programs forms or comprises an analysis tool which, in a first step, is arranged to retrieve data (information) from the data repository concerned, which data (information) is relevant for the system analyzed by the analysis tool and which data (information) consists, for example, of protocol information (J 1939, DeviceNet, etc), information about ECUs that are relevant for this system, etc, in that in a second step, the analysis tool is arranged to define for analysis the system's characteristics, for example type of protocol, ECUs, message frequencies, etc, by monitoring data communication established in the system, in that in a third step, the analysis tool can actively participate in the system and effect interrogation of ECUs, transmission of control data, etc, and in that in a fourth step, the analysis tool is arranged to generate reports in the said first format for the data repository about the current system characteristics.

4. Arrangement according to claim 3, characterized in that in a fifth step, a user adds additional information which the analysis tool separates into information which the analysis tool separates into information that can be processed and information that cannot be processed, and in that the analysis tool is arranged to forward the respective information that cannot be processed to the data repository.

5. Arrangement according to claim 4, characterized in that information from a first tool (computer program) that cannot be processed is arranged for retrieval from the repository by a second tool (computer program) which, utilizing additional information and processing, is arranged to generate information that the first tool is able to import and utilize.

6. Arrangement according to claim 5, characterized in that a third tool for module design is arranged to generate models of modules and to export these to the repository, in that a fourth tool for system design is arranged to import models of modules and to add information into the respective model to correspond to the designed system and give information at system level concerning how the modules interact, that is in summary to make a model of the system and export this information to the repository.

7. Arrangement according to claim 6, characterized in that a fifth tool is arranged to import the system model and simulate the system's function by adding parameters and variable information as a function of the time.

8. Arrangement according to claim 7, characterized in that the fifth tool comprises an output that can be connected to the data connection of an actual system and that can generate data on this from simulated models, in that one or more simulated modules can be replaced by actual modules and in that the fifth tool detects deviations between the behavior of the actual modules and corresponding simulated modules and exports the result of the detection of the repository.

9. Arrangement according to claim 7, characterized in that a sixth tool is arranged to generate an improved model of the system and its components using the generated data (information).

10. Arrangement according to claim 9, characterized in that a seventh tool is connected to a system in question and has access to the repository, and is arranged, with the transmission of monitored data traffic and information from the repository, to reconstruct a probable picture of the construction of the system, its components and its behavior.

11. Arrangement according to claim 10, characterized in that an eighth tool is arranged to import a model of a given system from the repository, to be connected to the actual system and, by monitoring and transmission of data traffic, to verify that the actual system conforms to the model and, if this is not the case, to report deviations and export this information to the repository.

12. Arrangement according to claim 11, Characterized in that the third and fourth tools are arranged to import from the repository data generated by the fifth, sixth, seventh or eighth tool in order to generate models that conform better to reality or to give the respective user or designer information about deviations and specify remedies.

13. Arrangement according to claim 12, characterized in that the respective repository is arranged to work with linking functionality which unambiguously guides the searcher to information entered in the repository, for example information about components (engine, axle, etc), function category (hot, quick, etc), function value (temperature, speed, etc), and so on, whereby system, system components, module, modules obtain common information that is valid for the system, the modules, etc.
